(19) United States
(12) Patent Application Publication
(10) Pub. No.: US 2010/0118679 A1
(43) Pub. Date: May 13, 2010

(54) MULTI-LAYER OPTICAL DISCS

(75) Inventors: Jacobus Maarten den Hollander, Eindhoven (NL); Donato Pasquariefllo, Kista (SE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 12/527,465

(22) PCT Filed: Feb. 19, 2008
(86) PCT No.: PCT/IB08/50590

§ 371 Date: Aug. 17, 2009

(30) Foreign Application Priority Data
Feb. 19, 2007 (EP) 07102621.5

(51) Int. Cl. G11B 3/74; G11B 7/24

(52) U.S. Cl. 369/94; 369/275.2; G9B/3.108; G9B/7.166

(57) ABSTRACT

An optical record carrier (30) comprising a plurality of information layers formed above a first surface of a substrate wherein at least one of the information layers is a re-writable cache layer is disclosed. The data that is read more than once is copied on to the re-writable cache layer when the recording/reproducing device is not in active use. Next time when the same data is requested, it can be read from the re-writable cache layer. This is advantageous since the data is stored un-fragmented on the re-writable cache layer and the re-writable cache layer can have higher read speeds than the other information layers in the optical record carrier. Therefore, the re-writable cache layer can improve the system performance in terms of read speed.

### FIELD OF THE INVENTION

The subject matter relates to multi-layer optical discs, and more specifically to multi-layer optical discs that can improve the read-out performance in terms of speed.

### BACKGROUND OF THE INVENTION

US patent 20020041564 discloses an optical information medium comprising at least two data layers for bearing information. As the amount of data stored on the optical information medium increases, it becomes more likely that some percentage of the data is read often and the remaining percentage of the data is read less often. Further, it is not always known a priori which data will be read often and which data will be read the least. This can affect the read-out performance.

It would be advantageous to have an optical record carrier that can improve the read-out performance. It would also be advantageous to have a recording/reproducing device that can improve the read-out performance.

### SUMMARY OF THE INVENTION

An optical record carrier comprising a plurality of information layers formed above a first surface of a substrate wherein at least one of the information layers is a re-writable cache layer is disclosed.

A recording/reproducing device for recording/reproducing data from an optical record carrier, the optical record carrier including a plurality of information layers formed above a first surface of a substrate wherein at least one of the information layers is a re-writable cache layer, the recording/reproducing device comprising a control unit arranged to cache the data that is reproduced more than once from the plurality of information layers on to the re-writable cache layer is disclosed.

Furthermore, the method of caching the data could be implemented with a computer program.

### BRIEF DESCRIPTION OF THE DRAWINGS:

The above mentioned aspects, features and advantages will be further described, by way of example only, with reference to the accompanying drawings, in which the same reference numerals indicate identical or similar parts, and in which:

FIG. 1 schematically shows the structure of an example four layer optical record carrier;

FIG. 2 schematically illustrates repeated read behavior of an example BD-R disc at read powers of 0.7 mW, 0.9 mW, 1.0 mW and 1.2 mW;

FIG. 3 schematically shows the structure of an example four layer optical record carrier according to an embodiment of the present subject matter;

FIG. 4 schematically illustrates repeated read behavior of the example optical record carrier shown in FIG. 1 and the optical record carrier according to an embodiment of the present subject matter shown in FIG. 3; and

FIG. 5 shows a schematic block diagram of an exemplary recording/reproducing device according to an embodiment of the present subject matter.

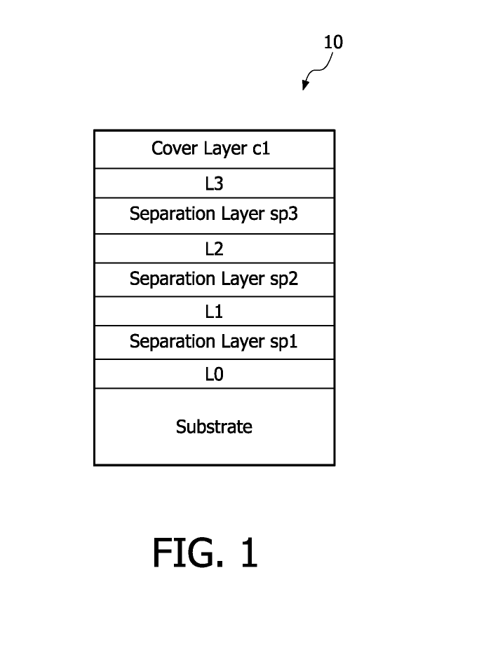

Referring to the example four layer optical record carrier 10 in FIG. 1, a plurality of information layers L0, L1, L2 and L3 is formed above a first surface of a substrate. A plurality of separation layers sp1, sp2 and sp3 is disposed between the information layers L0, L1 and L2 respectively. A cover layer c1 is disposed above the top information layer L3.

The transmission through the top information layer(s) has to be very high in order to record and read out all the information layers. The higher the number of information layers, higher will be the transmission needed by the top information layer. As an illustrative example the transmission of the individual information layers that are required to reach an effective reflection of 4% from each layer (4% reflection is the minimum reflection from each layer in the current Blu-ray disc standard (System description Blu-ray disc recordable format, Part 1, Basic format specifications; System description Blu-ray disc rewritable format, Part 1, Basic format specifications)) are calculated. The results are shown in Table 1.

TABLE 1
Calculated transmission through each
single individual information layer

| Information | Reflection | Transmission | Effective |
|---|---|---|---|
| layer | (individual layer), r | (individual layer), t | Reflection, R |
| L3 | 4% | 82% | 4% |
| L2 | 6% | 74% | 4% |
| L1 | 11% | 63% | 4% |
| L0 | 27% | 0% | 4% |

The data in Table 1 are calculated using the following formulas:

R₀=(t₃×t₂×t₁)²×r₀

R₁=(t₃×t₂)²×r₁

R₂=(t₃)²×r₂

R₃=r₃

where

tₙ and rₙ are the transmission and reflection from the individual information layers respectively; and

Rₙ is the reflectivity from the n^{th} layer (i.e., L3) in the four layer optical record carrier shown in FIG. 1.

It can be observed from Table 1 that the transmission of the top information layers L3, L2, and L1 need to be very high, i.e. 60-80%. Reaching such high transmission excludes the use of any metal layer in the top stacks. Metal layers are often used as heat sinks to improve cooling of the information stack. Therefore, unavoidably these upper layers will also have very poor cooling.

In most optical disc standards, for example System description Blu-ray disc recordable format, Part 1, Basic format specifications; System description Blu-ray disc rewritable format, Part 1, Basic format specifications, the “repeated read” is specified. It is often specified that one should be able to read out the data 1,000,000 times at a certain minimum read power without degrading the recorded data.

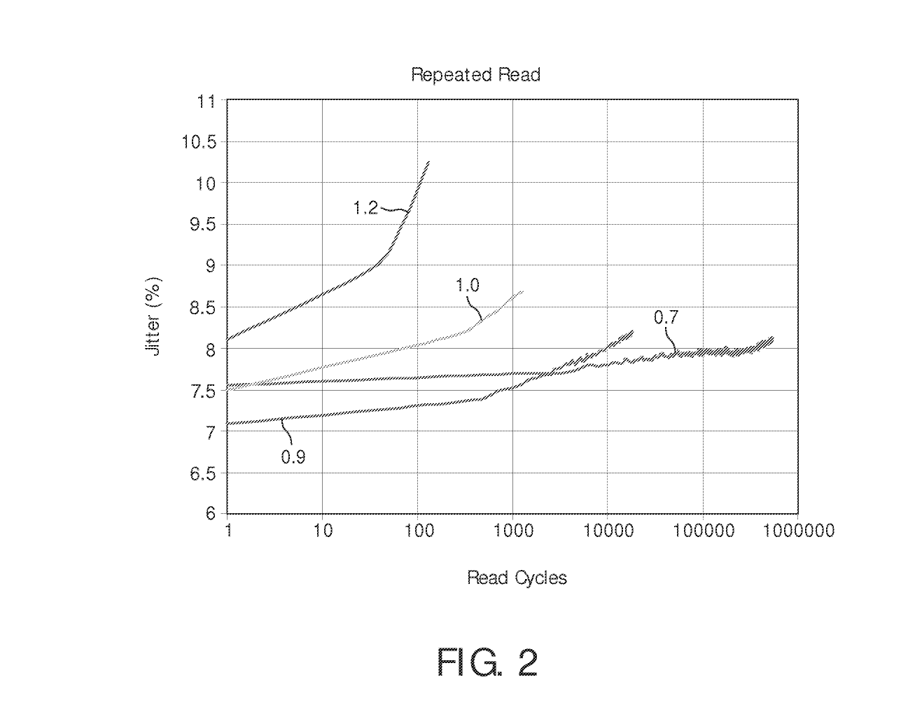

Referring to FIG. 2, the vertical axis represents the Jitter % and the horizontal axis represents the number of repeated read cycles. It can be seen that the higher the read power, the faster the jitter increases (data degrades). During repeated read the radiation source (e.g. laser) slowly heats up the disc, which causes degradation of the recorded data.

The better the cooling properties of the disc, the more stable the disc is during repeated read. Read stability is directly linked to the cooling properties of the stack.

Reading out data from a disc at speeds higher than 1×(4.92m/s for BD) normally also requires the read power to be increased (to improve signal-to-noise ratio). In practice this means that only discs with very good read stability can be read out at higher speeds.

### DETAILED DESCRIPTION OF THE EMBODIMENTS:

As the amount of data stored on the optical record carrier 10 increases (Cf. FIG. 1), it becomes more likely that some percentage of the data is read often and the remaining percentage of the data is read less often. Further, it is not always known a priori which data will be read often and which data will be read the least.

As an illustration, let us consider a navigation system, which retrieves its map-data from the optical record carrier 10. The optical record carrier 10 contains a detailed map of a large region including additional information (picture, movies etc). Even though the optical record carrier 10 is the same for user A and user B, each user will access different areas on the optical record carrier 10 based on their geographical location and interests.

An optical record carrier comprising a plurality of information layers formed above a first surface of a substrate wherein at least one of the information layers is a re-writable cache layer is disclosed.

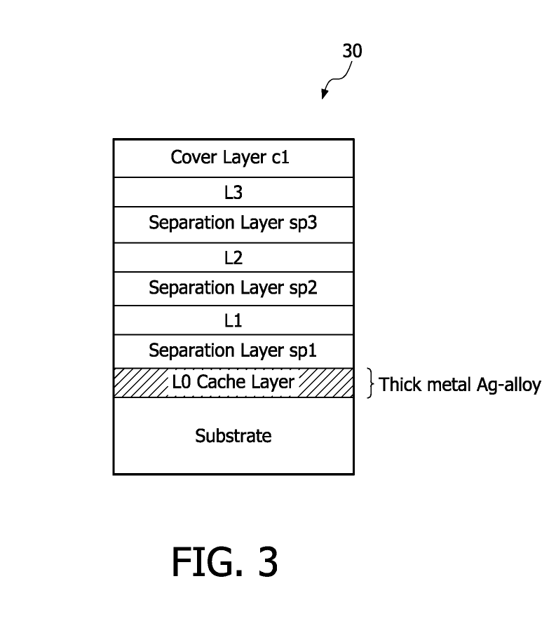

Referring to FIG. 3, a plurality of information layers L0, L1, L2 and L3 is formed above a first surface of a substrate. A plurality of separation layers sp1, sp2 and sp3 is disposed between the information layers L0, L1 and L2 respectively. A cover layer c1 is disposed above the top information layer L3. One of the information layers L0, L1, L2 and L3 is used as a cache layer for caching purposes. For illustration, the first information layer L0 is shown as a re-writable cache layer.

The data that is read more than once is copied on to the re-writable cache layer when the recording/reproducing device is not in active use. Next time when the same data is requested, it can be read from the re-writable cache layer. The re-writable cache layer has a higher read speed than the other information layers in the optical record carrier 30 (Cf. FIG. 3). Therefore, the re-writable cache layer can improve the system performance in terms of speed. In other words, the re-writable cache layer provided in the optical record carrier 30 (Cf. FIG. 3) contains the data that is read more often and thereby offers an improvement in the read-out speed. Furthermore, the data read more often can be fragmented over the optical record carrier 30. Having a re-writable cache layer is advantageous in improving the read out speed since an un-fragmented copy of this frequently read data can be read from the re-writable cache layer. It has the further advantage that the contents of the cache can be updated in case the behavior model of the recording/reproducing device changes. Different parts of the data can be read more often when the behavior model of the recording/reproducing device changes.

In a further embodiment, the re-writable cache layer is the first information layer L0 (Cf. FIG. 3) above the first surface of the substrate. This is advantageous since the first information layer is the layer that has good read stability in terms of read-speed and repeated read because it has a substantially thick metal layer which improves cooling. It is further noted here that the first information layer is the bottom information layer (i.e. the information layer farthest from the radiation beam source) as viewed from a recording/reproducing unit.

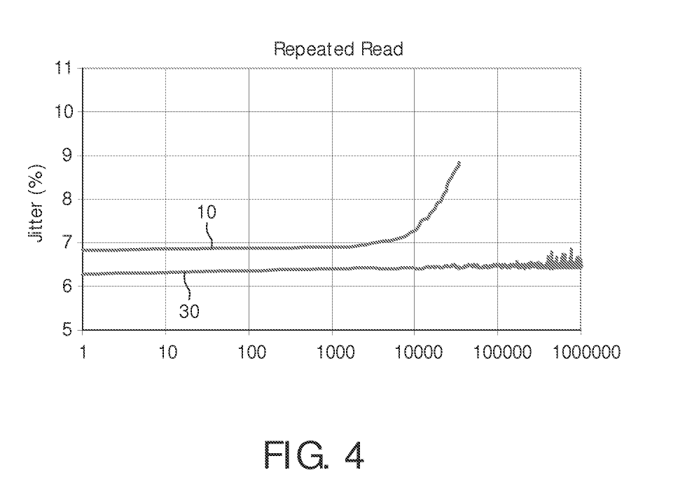

In a still further embodiment, the re-writable cache layer is disposed adjacent to a substantially thick metal layer. FIG. 4 schematically illustrates repeated read behavior of the example optical record carrier 10 without the metal layer (Cf. FIG. 1) and the example optical record carrier 30 with the metal layer (Cf. FIG. 3). The horizontal axis represents the number of repeated reads and the vertical axis represents the jitter %. Optical record carrier 10 (i.e. without metal layer) reaches about 10,000 read cycles before the jitter starts to increase, whereas the optical record carrier 30 (i.e. with substantially thick metal layer) is stable to over 1,000,000 read cycles. The thick metal layer (e.g. Ag-alloy) in the optical record carrier 30 improves cooling of the stack; consequently the repeated read stability is very good.

In a still further embodiment, the re-writable cache layer is arranged to cache the data that is read more than once from the plurality of information layers. This is advantageous in case the frequently read out data is fragmented over more than one information layer.

In a still further embodiment, the information layers other than the re-writable cache layer are selected from a read only layer, a write-once layer and a re-writable layer. This is advantageous since the frequently used data can be fragmented over the optical record carrier.

The file system, which uses the recording/reproducing device, copies the data that is read more than once to the re-writable cache layer for caching purposes. Commonly known cache algorithms can be applied in case the cache is full or when the original contents have changed. Writing data on the re-writable cache-layer can be done in idle-time to avoid system performance degradation. Idle time period is the time period during which the recording/reproducing device is not used actively (i.e. not in operation). The re-writable cache layer offers several advantages to the overall system performance. Some of the advantages are:

1. All the data that is frequently accessed can be stored un-fragmented on the re-writable cache layer. This allows a burst-type access, which is fast on the recording/reproducing device.
2. All the data that is read often is located at layer L0 (Cf. FIG. 3), which is the layer with the highest-readout speed of all information layers in the stack.
3. The re-writable cache is non-volatile which means that even after a power down of the recording/reproducing device, the cache contents are not lost. Consequently, after power-up, the recording/reproducing device can immediately benefit from the cache without the need to fill it first.
4. Because the re-writable cache is on the optical record carrier 30 (Cf. FIG. 3), the re-writable cache can immediately be accessed after the optical record carrier 30 is inserted (provided the use model has not changed) without the need to fill/build-up the cache first.

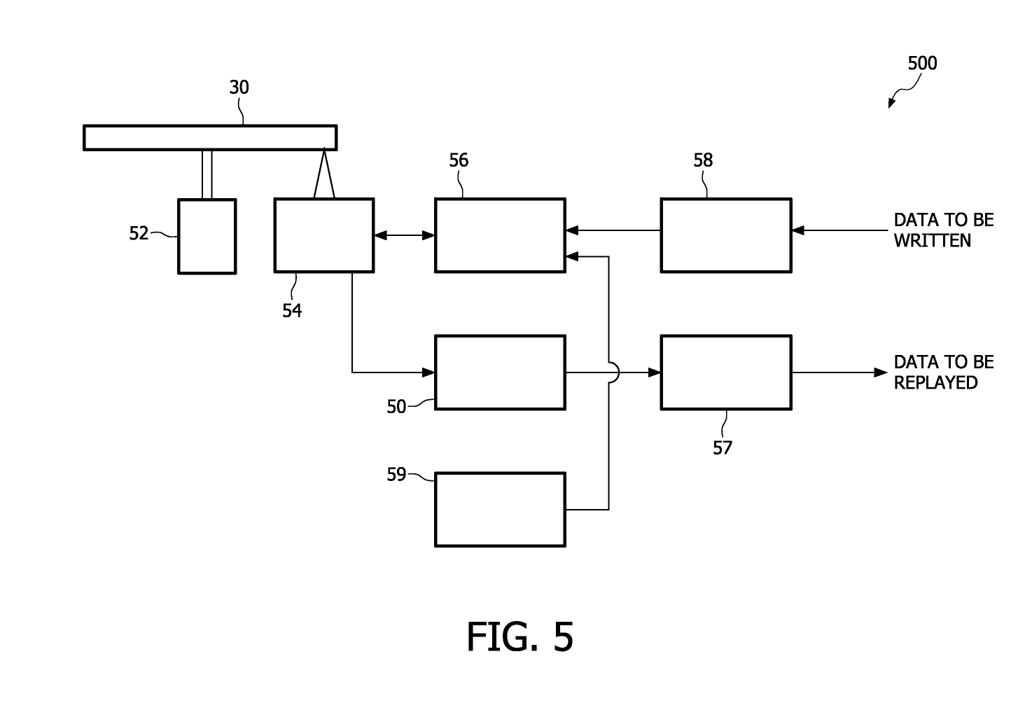

FIG. 5 is a block diagram showing structures of an example recording/reproducing device 500 used for recording/reading the optical record carrier 30 (Cf. FIG. 3).

The optical record carrier 30 is constant angular velocity (CAV) controlled or constant linear velocity (CLV) controlled by a spindle motor 52. An optical pick-up unit 54 records data on the optical record carrier 30 by using laser light (at a recording power value) emitted from a laser diode. When the data is to be recorded, it is supplied to an encoder unit 58 and the data encoded by the encoder unit 58 is supplied to a laser diode-driving unit 56. The laser diode-driving unit 56 generates a drive signal based on the encoded data and supplies the drive signal to the laser diode of the optical pick-up unit 54. In addition, a control signal from a control unit 54 is supplied to the laser diode-driving unit 56 so that the recording strategy and recording power are determined by the control signal. However, when data is read from the optical record carrier 30, the laser diode of the optical pick-up unit 54 emits laser light of a read power (read power<record power), and the reflected light is received. The received reflected light is converted into an electrical signal and a read RF signal is obtained. The read RF signal is supplied to an RF signal-processing unit 50.

The RF signal-processing unit 50 comprises an equalizer, a binarizing unit, a phase-locked loop (PLL) unit, and binarizes the read RF signal, generates a synchronous clock, and supplies these signals to a decoder unit 57. The decoder unit 57 decodes the data based on these supplied signals and outputs the decoded data as read data.

The recording/reproducing device 500 also includes a circuit (for data readout) for controlling the focus servo or tracking servo by producing a tracking error signal or a focus error signal respectively, and a wobble signal formed on the optical record carrier 30 (e.g. for use in address demodulation or for controlling the number of rotations). The servo control structures are identical to those in conventional recording/reproducing systems and therefore are not described in detail.

The construction shown in FIG. 5 only illustrates portions related to the general operation of the recording/reproducing device 500. The description and detailed explanation of servo circuits for controlling the optical pick-up unit, the spindle motor, the slide motor, and the control circuits are omitted, because they are constructed in a similar manner as in conventional recording/reproducing systems.

The control unit 59 is arranged to cache the data that is reproduced more than once from the plurality of information layers (Cf. FIG. 3) on to the re-writable cache layer.

In an embodiment, the control unit 59 is further arranged to cache the data that is reproduced more than once from the plurality of information layers on to the cache layer during the idle-time of the recording/reproducing device, the idle-time being the time period during which the recording/reproducing device is not in active use (i.e. not in operation).

It is noted here that the control unit 59 does more than only copying content to the re-writable cache layer. The control unit also handles read command. It checks if a read request can be serviced by the data in the cache and if so instructs the recording/reproducing device to read the data from the re-writable cache layer instead.

Although the present subject matter has been explained by means of embodiments using four-layer Blu-ray discs, the subject matter is applicable to all types of optical record carriers. Further, the subject matter is not limited to a two-layer one side disc, i.e., a dual layer disc, and to a two-layer double-side disc, i.e., a dual layer double-side disc. A person skilled in the art can implement the described embodiments of the method of caching data on to the re-writable cache layer in software or in both hardware and software. Other variations to the disclosed embodiments can be understood and effected by those skilled in the art of practicing the claimed subject matter, from a study of the drawings, the disclosure and the appended claims. The user of the verb “comprise” does not exclude the presence of elements other than those stated in a claim or in the description. The use of the indefinite article “a” or “an” preceding an element does not exclude the presence of a plurality of such elements. The Figures and description are to be regarded as illustrative only and do not limit the subject matter.

1. An optical record carrier (30) comprising:
a plurality of information layers formed above a first surface of a substrate wherein at least one of the information layers is a re-writable cache layer.

2. The optical record carrier as claimed in claim 1, wherein the re-writable cache layer is the first information layer above the first surface of the substrate.

3. The optical record carrier as claimed in claim 1, wherein the re-writable cache layer is disposed adjacent to a substantially thick metal layer.

4. The optical record carrier as claimed in claim 1, wherein the re-writable cache layer is arranged to cache the data that is read more than once from the plurality of information layers.

5. The optical record carrier as claimed in claim 1, wherein the information layers other than the re-writable cache layer are selected from a read only layer, a write-once layer and a re-writable layer.

6. A recording/reproducing device (500) for recording/reproducing data from an optical record carrier, the optical record carrier including a plurality of information layers formed above a first surface of a substrate wherein at least one of the information layers is a re-writable cache layer, the recording/reproducing device comprising:
a control unit (59) arranged to cache the data that is reproduced more than once from the plurality of information layers on to the re-writable cache layer.

7. The recording/reproducing device as claimed in claim 6, wherein the control unit is further arranged to:
cache the data that is reproduced more than once from the plurality of information layers on to the re-writable cache layer during the idle-time of the recording/reproducing device, the idle-time being the time period during which the recording/reproducing device is not in active use.

8. A computer program code means arranged to perform a method of reproducing data from an optical record carrier, the optical record carrier including a plurality of information layers formed above a first surface of a substrate wherein at least one of the information layers is a re-writable cache layer, the method comprising:
caching the data that is reproduced more than once from the plurality of information layers on to the re-writable cache layer.
